(19) United States
(12) Patent Application Publication
(10) Pub. No.: US 2014/0181004 A1
(43) Pub. Date: Jun. 26, 2014

(54) Common Framework for Definition, Generation, and Management of Metadata Runtime-Loads

(71) Applicant: SAP AG, Walldorf (DE)

(72) Inventors: Bare Said, St. Leon (DE); Frank Jentsch, Muhlhausen (DE); Frank Brunswig, Heidelberg (DE)

(73) Assignee: Sap AG, Walldorf (DE)

(21) Appl. No.: 13/721,677

(22) Filed: Dec. 20, 2012

(51) Int. Cl. G06F 17/30

(52) U.S. Cl. CPC G06F 17/30563
USPC 707/602

(57) ABSTRACT

A system, a method, and a computer-program product for management of runtime-loads in business process applications are disclosed. Metadata associated with an application is identified. The metadata is configured to enable loading during a runtime of the application and is stored on at least one node in a metadata repository. A runtime-loading structure for loading the metadata during the runtime of the application is generated based on the identified metadata. The runtime-loading structure contains an identification of the at least one node storing the identified metadata in the metadata repository. The identified metadata is loaded based on the generated runtime-loading structure during the runtime of the application.

### TECHNICAL FIELD

This disclosure relates generally to data processing and, in particular, to management of runtime-loads in business process applications.

### BACKGROUND

In today's world, businesses frequently use business process applications to perform various tasks for them. The business process applications can assist businesses with customer relationship management (“CRM”) to help businesses acquire and retain customers, gain marketing and customer insight, product lifecycle management (“PLM”) to help manufacturers with product-related information, supply chain management (“SCM”) to help businesses with the process of resourcing its manufacturing and service processes, supplier relationship management (“SRM”) to enable businesses to procure from suppliers, as well as other needs. The business process application typically include software applications that are designed by developers at the design time of an application and configured to execute later at runtime.

Conventional business process systems manually perform customized runtime data loading, which consume a significant amount of processing, time and can be very costly. Further, such manual runtime data loading is performed by users (or metadata consumers) of the business process application. This error-prone and complex task also forces most of the metadata consumers and, especially, secondary consumers to work and operate with the original metadata and retrieving the metadata by executing a bunch of retrieve and retrieve-by-association operations. This further results in delay, errors, added costs, and/or other undesired consequences.

### SUMMARY

In some implementations, the current subject matter relates to a computer-implemented method for management of runtime loads in business process applications. The method can include identifying a metadata associated with an application, wherein the metadata is configured to enable loading during a runtime of the application and is stored on at least one node in a metadata repository, generating, based on the identified metadata, a runtime-loading structure for loading the metadata during the runtime of the application, the runtime-loading structure containing an identification of the at least one node storing the identified metadata in the metadata repository, and loading, based on the generated runtime-loading structure, the identified metadata during the runtime of the application. At least one of the identifying, the generating, and the loading can be performed on at least one processor.

In some implementations, generation of the runtime-loading structure can include determining at least one attribute of the identified metadata and generating, using the determined attribute, an access path for accessing the identified metadata during runtime of the application. Generation of the access path can be performed on a metadata level of the metadata repository. In some implementations, loading of the identified metadata can include retrieving the identified metadata associated with the at least one node and at least one data type of the identified metadata and loading, using the generated access path, the identified metadata and retrieved associated metadata during runtime of the application.

In some implementations, loading of the identified metadata can include determining whether a runtime-loading structure for loading the metadata during runtime of the application has been previously generated, loading, using the previously generated runtime loading structure, the identified metadata during runtime of the application, and generating another runtime-loading structure for loading the identified metadata and loading the identified metadata during runtime of the application when the runtime-loading structure has not been previously generated.

In some implementations, the metadata can be loaded based on at least one metadata model stored in the metadata repository. The generation of the loading structure can include generating, based on the at least one metadata model, the runtime-loading structure on a meta-metadata level of the metadata repository, and preparing, based on the runtime-loading structure, the identified metadata stored on a metadata level of the metadata repository for loading during runtime of the application.

In some implementations, the loading further can include loading the identified metadata during a design-time of the application. The loading of the identified metadata can be optimized for performance during the runtime of the application.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary runtime-load framework, according to some implementations of the current subject matter;

FIG. 2 illustrates an exemplary method for generating a runtime-load definition, according to some implementations of the current subject matter;

FIG. 3 illustrates an exemplary runtime-load structure, according to some implementations of the current subject matter;

FIGS. 4a-b illustrate exemplary data-retrieval catalogs that can be used for provisioning of a runtime-load, according to some implementations of the current subject matter;

FIG. 5 illustrates an exemplary method for providing implementation data types for a business object, according to some implementations of the current subject matter;

FIG. 6 illustrates an exemplary system, according to some implementations of the current subject matter; and

FIG. 7 illustrates an exemplary method, according to some implementations of the current subject matter.

### DETAILED DESCRIPTION

During runtime, an application of a business system may require use and/or loading of various data, metadata, etc. that can correspond to, and/or may be needed by, various business process objects during runtime execution of the application (also referred to as a business process software application). The various data can be stored in a repository and can be loaded when called by the application during runtime. However, this storage and calling of the data when needed during runtime can be a time consuming task.

To address the above-noted and potentially other deficiencies of currently available solutions, one or more implementations of the current subject matter provide methods, systems, articles or manufacture, and the like that can, among other possible advantages, provide systems and methods for providing systems, methods, and computer program products for managing runtime-loads in applications, which are also referred to herein as business process software applications, business process applications, and/or business application.

To illustrate, applications can be provided with an ability to define, generate, and/or manage runtime-loading of metadata that can correspond to business process objects of the applications. Initially, a runtime-load of metadata for a business object (or an application) can be defined, which can include identification of attributes associated with the runtime-load metadata, generation of runtime-load structure, and generation of a runtime-load catalog that can indicate how to retrieve the metadata during runtime. The metadata runtime-load definition procedure can be performed by using a user interface associated with the business object (or application) to navigate to, or locate in, a repository the metadata that should be loaded at runtime. An application programming interface (“API”) can be also generated to allow easy access to the metadata for runtime-loading. Once the runtime-load metadata is defined, a runtime-load processing engine can perform runtime-loading of data during execution of the business object (or application) during runtime. To retrieve metadata stored in a repository, the runtime-load processing engine can obtain all node definitions that can store metadata for runtime-loading as well as data types related to the metadata. The runtime-load processing engine can execute at least one retrieve and/or retrieve-by-association operation to obtain node definitions, data types, and/or other information related to the metadata. The engine can also create a memory object based on the retrieved metadata for use during runtime. The current subject matter can also perform runtime-load management operations, including at least one of the following: allowing users to use already existing runtime-loads or create new ones, performing lifecycle management operations, e.g., ensuring consistency of metadata access paths, accuracy of created metadata catalogs, etc.

Data and any associated metadata can be stored in a memory (e.g., a Metadata Model Repository (“MDRS”) as provided by SAP AG, Walldorf, Germany). The data warehouse can contain meta-information about the data. The data can be stored in various layers: M0, M1, M2, and M3. Layer M0 is a data layer; layer M1 is a metadata layer that can include a data model indicative how the data can be stored; layer M2 is a meta-metadata layer that can include a meta model indicative of how the metadata can be stored; and layer M3 is a meta-meta-metadata layer that can include a meta-meta model indicative of how the meta-metadata can be stored.

During design-time of an application, various data in a metadata repository can be selected for access/retrieval during runtime of the application. The metadata repository data can be accessed and/or retrieved by the application using a specific model, an implementation class, etc.

The metadata repository can contain models and metadata models that can be used in different contexts and by different users. For better performance and better response time metadata repository metadata can be transformed in highly optimized runtime-loads. The current subject matter can enable metadata users to easily create their own tailored and optimized runtime-loads that allow them to avoid accessing normalized metadata repository metadata directly without compromising on consistency. The current subject matter can also provide a common framework that can enable metadata users to operate directly using tailored runtime loads. The framework can provide various functionalities that define, generate, and/or manage the tailored runtime loads for each metadata user independent of the metadata origin and/or layer the metadata user can be located in.

In some implementations, the framework can be integrated using design time and/or runtime development tools. The framework can offer metadata users a possibility to define tailored runtime-loads. A runtime-load can be defined on the metadata model level, i.e., the M2 level of the metadata repository. This approach can allow a generic provisioning of runtime-loads for all models of such metadata model. On the metadata model level (e.g., meta object business object), users can define one or several sets of metadata that can be part of the runtime load. This definition can be executed by tagging the metadata with a runtime load identifier and specifying a complete access path to the data. Specified access paths are not restricted to one metadata object and can go across metadata objects (e.g., navigation to data type information of a node element). Once the runtime load is defined, the framework can generate a corresponding runtime-load structure that can represent an optimized join view on any needed metadata. For each generated runtime load structure, corresponding access paths on metadata model level M2 can be stored. The stored access paths can represent a generic algorithm for framework-runtime engine in order to retrieve metadata for each M1 model using the M2 model.

When the generated runtime-load structures are requested by the user for the first time, a load provisioning component of the application can be triggered and the origin metadata can be retrieved and transformed to the runtime-load structure format. The created runtime-loads can be created as shared memory objects that can be available across different sessions. Further requests of the runtime-load already available in the shared memory can be answered immediately and without any additional transformation or cascaded retrieval steps.

In some implementations, the runtime load framework can be integrated directly in the metadata repository and can detect any changes to the original metadata. In case of metadata changes, the framework can determine the impacted runtime-loads and invalidate them, if necessary. Once the invalidated runtime-load are accessed, they can be generated again and metadata can be retrieved and re-transformed again. Besides runtime-load provisioning and invalidation the framework can offer various additional capabilities, which can include at least one of the following: transport management and runtime-load exploring for better management and finding of runtime-loads.

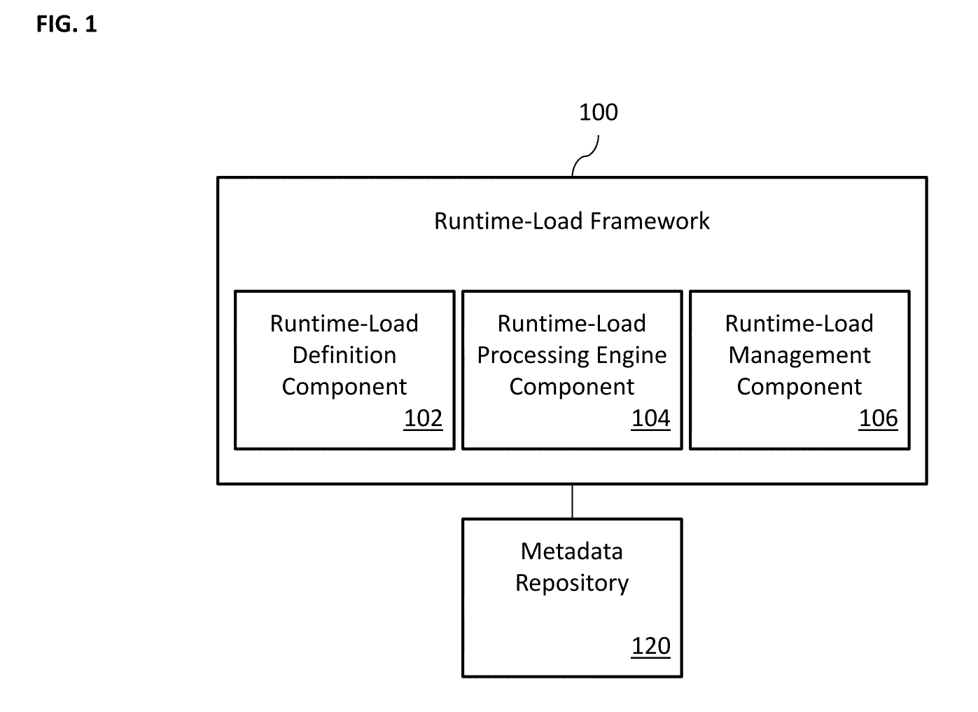

FIG. 1 illustrates an exemplary runtime-load framework 100, according to some implementations of the current subject matter. The framework 100 includes a runtime-load definition component 102, a runtime-load processing engine component 104, and a runtime-load management component 106. The framework 100 can be also coupled to the metadata repository 120 (e.g., MDRS) to obtain appropriate metadata.

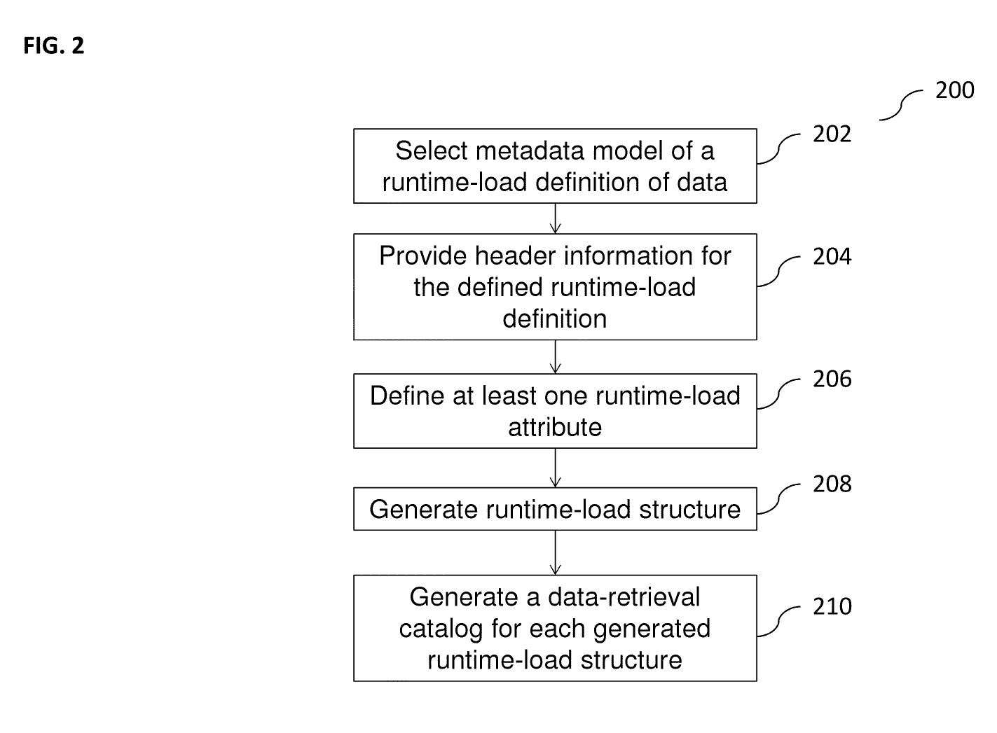

The runtime-load definition component 102 can perform various operations in connection with defining runtime-load data and/or structure using the data in the metadata repository. FIG. 2 illustrates an exemplary method 200 for generating a runtime-load definition, according to some implementations of the current subject matter. The runtime-load definition component 102 can access the metadata model level M2 to obtain data and/or metadata model for creating a runtime-load. For example, a runtime-load can be defined for a metadata model related to various business object in an application (e.g., a sales order application).

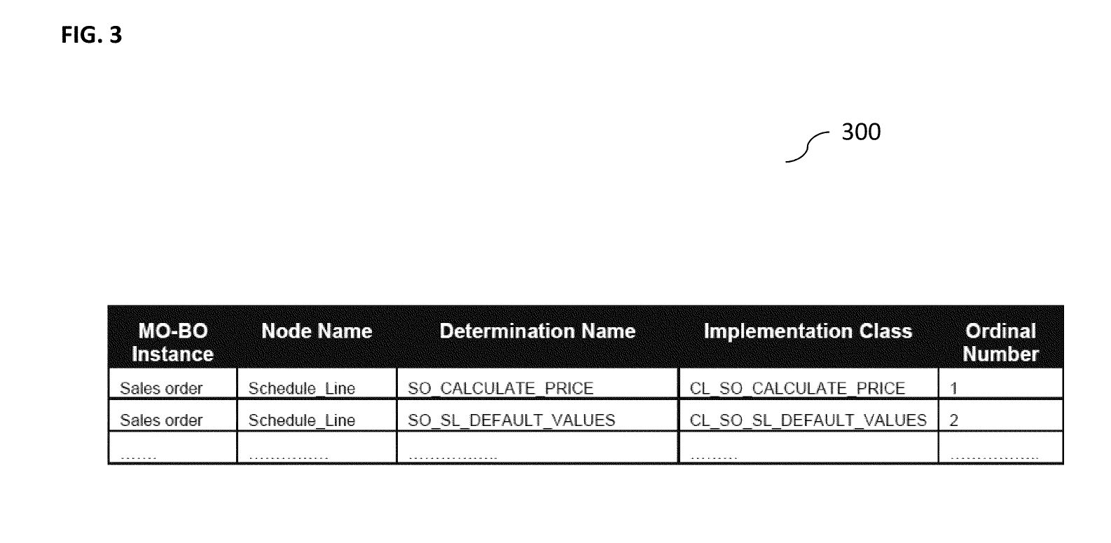

At 202, metadata model of a runtime-load definition of data can be selected in the metadata repository in metadata model level M2. At 204, a header information for the defined runtime-load definition can be provided. For example, the header information can include at least one of the following: a name, a description, an origin metadata model, creator information (e.g., consumer name, development package information, consumer development package information), and/or any other information. At 206, at least one runtime-load attribute can be defined. This can be accomplished by navigating to the needed metadata in the metadata model level M2 of the metadata repository (e.g., data type implementation) and tagging/selecting all relevant attributes that can be part of the runtime-load structure. The attributes can include root node information for a particular data, parent-node information for the data, child-node information for the data, data type, and/or any other attributes that can be used for determining how to create a path for the purposes of retrieving data during runtime. Once the attributes are determined, the runtime-load structure can be generated, at 208. An exemplary runtime-load structure 300 is shown in FIG. 3. As shown in FIG. 3, the structure 300 can be in a form of a table that can include information about model object-business object (“MO-BO”) instance, node name where a particular data can be located, determination name for the data to be retrieved during runtime, implementation class for the data to be retrieved during runtime, an ordinal number (i.e., 1, 2, . . . ). As shown in FIG. 3 the MO-BO instance corresponds to a sales order object that can be stored in a schedule line node of the metadata repository. The sales order object can include classes for calculation of process and default values corresponding to the sales order object, where calculation of the price takes place first (as indicated by the ordinal number 1) and the determination of default values takes place second (as indicated by the ordinal number 2).

Referring back to FIG. 2, at 210, a data-retrieval catalog for each generated runtime-load structure can be generated. The catalog can include a navigation/access path for each attribute in the runtime-load. The catalog can be a generic path-description on M2 level that can be used by the runtime-load processing engine 104 of the framework (shown in FIG. 1) in order to provide runtime-loads for all models or instances of the M2 metadata.

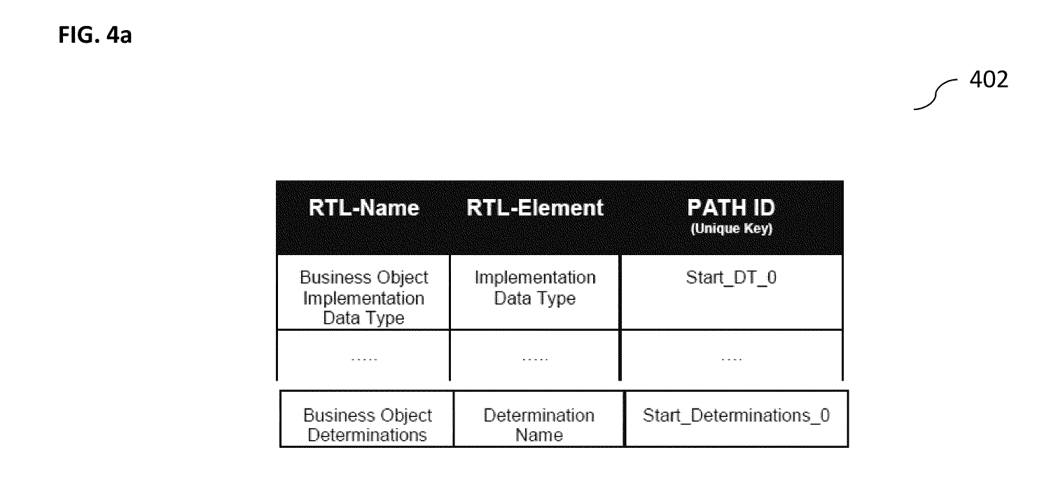

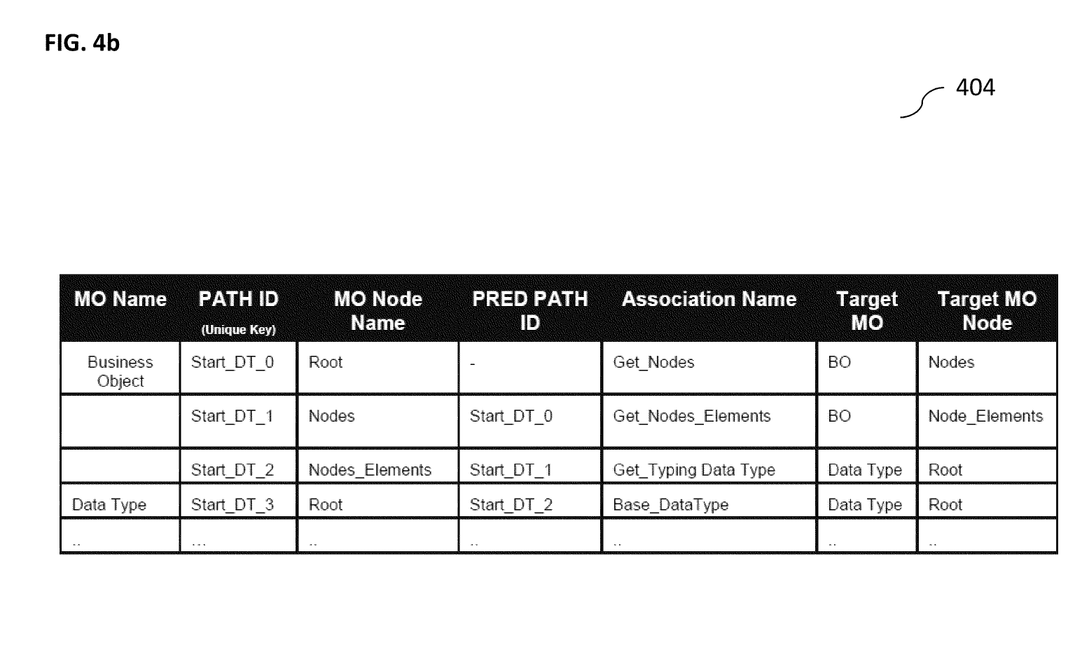

FIGS. 4a-4b illustrate exemplary data-retrieval catalogs that can be used for provisioning of a runtime-load. FIG. 4a illustrates a runtime-load data-retrieval catalog 402. The catalog 402 can be generated in a form of a table and can include a runtime-load (“RTL”) name, a runtime-load element, and a unique path identifier. As shown in FIG. 4a, the RTL-name can be a business object implementation data type, business object implementations, and/or any other name. The RTL-element can include an implementation data type, a determination name, and/or any other RTL-element. The path identifier can indicate where the data can be located in the metadata repository.

FIG. 4b can include further information, such as, metaobject name, metaobject node name, association names, target metaobject name, target metaobject node, and/or various path identifiers. The metaobject names can be business objects (“BO”), data types, etc. The path identifiers can identify where the data is located in the metadata repository and where the application should start looking for the data requested during runtime. The metaobject nodes can indicate where the data is located (e.g., MO Node name) and where the data is to be transferred as a result of the runtime-load (e.g., Target MO and Target MO Node). The association name can indicate what functions are to be performed to obtain data during runtime load.

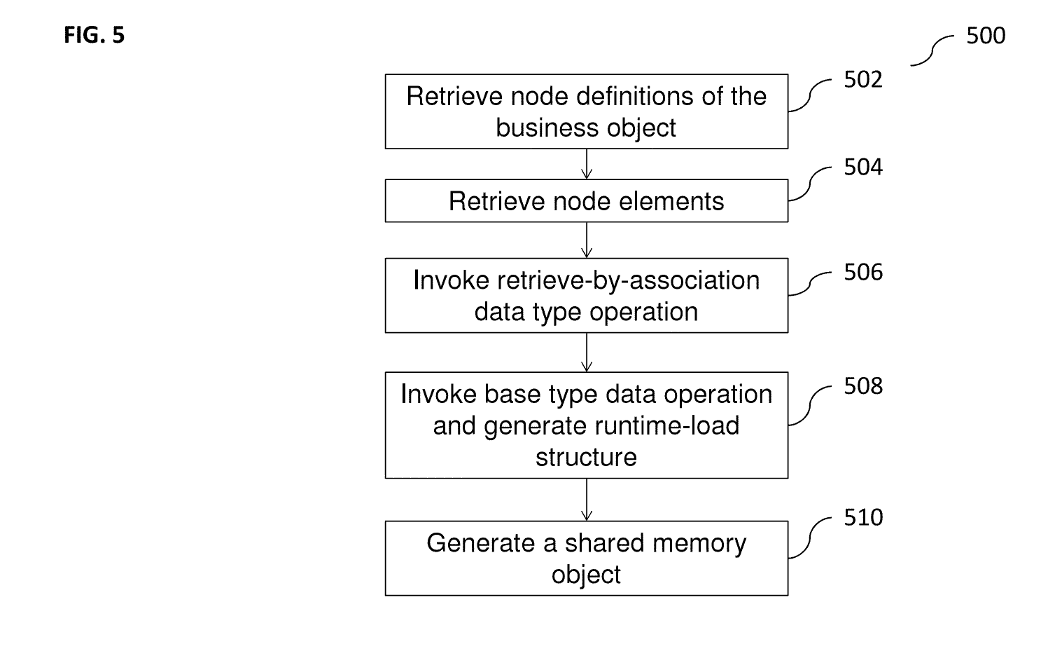

Referring back to FIG. 1, the runtime-load processing engine 104 can be responsible for initiating of the runtime-load. The initiation can be triggered, for example, when a metadata consumer invokes an access application programming interface (“API”) of an application that can correspond to a specific runtime-load, which might not be already available in the shared memory. The processing engine 104 can rely on the generated runtime-load structure (generated at 208 in FIG. 2) and the generated access paths catalog (generated at 210 in FIG. 2) during the initiation of the runtime-load. For example, in order to provide implementation data types for a business object, the processing engine 104 can perform at least one of the following operations, as shown in FIG. 5.

At 502, node definitions of a business object in the application can be retrieved. For example, node definitions of the business object that can implement data types can be retrieved. At 504, for each node, the node elements can be retrieved by invoking the retrieve-by-association operation. For example, the retrieve-by-associate option can include an association name “Get Node Elements”. At 506, for each node element, the retrieve-by-association operation with association name that can relate to the data type can be invoked (e.g., “Get Typing Data Type”). The result-set of this operation can be assigned to a metadata data type object (e.g., “MO Data Type”). At 508, for each data type, a base data type operation can be invoked and based on the data type and base data type, a runtime-load structure can be created. At 510, a shared memory object based on the runtime-load structure can be generated.

In some implementations, the above initiation process can be performed once and based on that all further accesses to an already initiated runtime-load can be answered more quickly and without a need for additional metadata retrieval operations.

Referring back to FIG. 1, the framework 100 can also include a runtime-load management component that can perform various lifecycle management operations of the metadata and corresponding generated runtime-load structures. The generated runtime-load structures can be metadata repository objects, which can be linked to their origin metadata model using cross-metadata model associations that can be exist in the metadata repository or be separately generated by the runtime-load definition component 102 and/or runtime-load processing engine component 104. To obtain a particular runtime-load structure, a source metadata model, such as for example, a business object metadata model stored in the metadata repository, can be accessed. A metadata model consumer can use an already existing runtime-load or can define a new one. The generated structures and access paths catalog for a runtime-load can be transported together with the source metadata model. This can simplify lifecycle management and consistency of development and design time artifacts. Changes can executed on metadata model level such as metaobject business object and/or on model level, such as, business object sales order, can be noticed immediately by the runtime-load management component 106. This is because the component 106 can be part of the metadata repository. In case of any changes, the corresponding runtime-load structures and/or the runtime-load already residing in the shared memory can be immediately invalidated to avoid potential data inconsistency.

The following example illustrates operation of the framework 100. The framework can be implemented in connection with SAP Business ByDesign fully integrated on-demand enterprise resource planning and business management software product (as available from SAP AG, Walldorf, Germany). Assuming, a generic mass data migration workbench software application is provided that can extract business data from a legacy system and transform that data in an appropriate data format, and then push the data into the business processing system. Data can be transformed in the appropriate data format and validated and completed via predetermined validation and determination procedures. Concrete data format as well as relevant validation and determination procedures can be retrieved as additional metadata of a specific business object. Business objects such as sales orders, business partners, etc. can be models that can encapsulate business logic related to those business domains. For the generic migration workbench in this example metadata can be retrieved for various models in order to execute relevant validation and determination procedures or in order to transform the data in the target format.

During data transformation, an internal buffer structures having the same format as the data format of the business objects need to be migrated, can be defined. In order to define the internal buffer structures, the concrete data types in the target data type system can be determined. Data type information can be part of business objects metadata. For the used or involved business objects all node element structures can be determined and then for each element of the node elements structure the data type metadata can be retrieved. The metadata of data type can contain detailed information about the used technical type category (e.g., CHAR) and a maximum length (e.g., 60). To retrieve and analyze metadata, a huge amount of retrieve, retrieve-by-association (e.g., intra metadata object, cross metadata object, etc.) operations can be executed. The cascaded metadata retrieval is a time-consumption activity that shall be avoided as much as possible.

For example, in order to retrieve the system data type for Product ID, several retrieve by association operations can be executed on the MO Business Object for the Sales Order model. Once the data type information is determined on the node element level, the retrieve operation on the MO data type can be executed to determine the concrete implementation data type or the native system data type.

In order to determine concrete determination and validation procedures implementations, a long path and a sequence of metadata retrieve operations can be executed. During data migration of specific business data, some determination and/or validation procedures can be executed on the business data in order to complete it and/or ensure its consistency. Repetitive traversing of metadata paths can be avoided by retrieving the needed metadata once and providing it as a runtime-load accessible as shared memory object.

Thus, in some implementations, the current subject matter can provide a common framework for definition, generation and/or management of metadata runtime-loads. The framework can be integrated in a metadata model repository and leverage repository capabilities in order to provide its own generic and common services that can be based on M2 metadata models residing in the metadata repository. The framework can enable metadata consumers independent from the layer they are located in (e.g., infrastructure layer, application layer, etc.) and independent from their relationship to the source metadata model (e.g., primary consumer, secondary consumer, etc.) to create their own tailored runtime-loads and take over complicated and/or error-prone activities needed to manage the created runtime-load. This service can encourage the metadata consumers to operate on runtime-load instead of operating on the origin metadata persisted in the metadata repository. Accessing metadata via tailored runtime-loads and not via direct access on the metadata persisted in the metadata repository can increase performance of the application and reduce the response-time and the processing load.

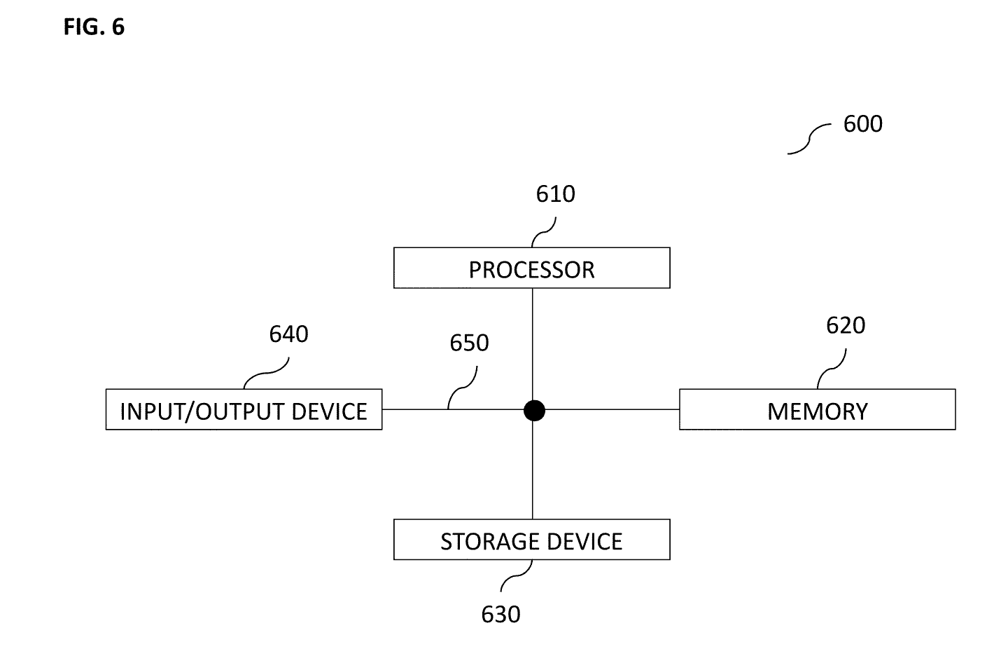

In some implementations, the current subject matter can be configured to be implemented in a system 600, as shown in FIG. 6. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some implementations, the storage device 630 can be a computer-readable medium. In alternate implementations, the storage device 630 can be a floppy disk device, a hard disk device, an optical disk device, a tape device, non-volatile solid state memory, or any other type of storage device. The input/output device 640 can be configured to provide input/output operations for the system 600. In some implementations, the input/output device 640 can include a keyboard and/or pointing device. In alternate implementations, the input/output device 640 can include a display unit for displaying graphical user interfaces.

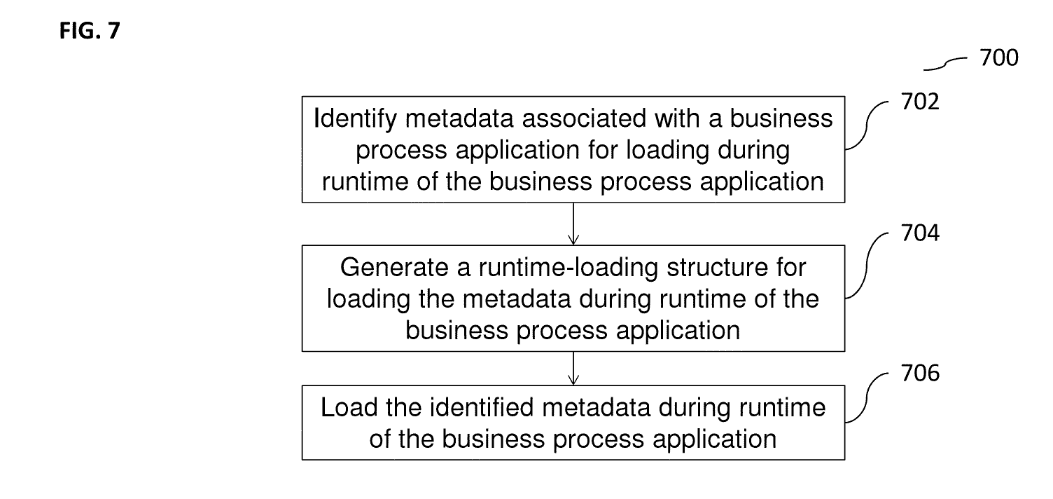

FIG. 7 illustrates an exemplary method 700, according to some implementations of the current subject matter. At 702, at least one metadata associated with an application for loading during runtime of the business process application can be identified. The metadata can be stored on at least one node in a metadata repository. The metadata identification or definition process is illustrated and discussed in connection with FIG. 2 above.

At 704, a runtime-loading structure for loading the metadata during runtime of the application can be generated based on the identified metadata. The runtime-loading structure can contain identification of at least one node storing the identified metadata in the metadata repository. Identification of at least one node storing the metadata is discussed above in connection with FIG. 2.

At 706, the identified metadata can be loaded during runtime of the application based on the generated runtime-loading structure. This process can be performed by the runtime-load processing engine 104 (as shown in FIG. 1).

At least one of the identifying, the generating, and the loading can be performed on at least one processor.

In some implementations, the current subject matter can include at least one of the following optional features. The generation of the runtime-loading structure can include determining at least one attribute of the identified metadata and generating, using the determined attribute, an access path for accessing the identified metadata during runtime of the application. The generation of the access path can be performed on a metadata level of the metadata repository.

In some implementations, the loading operation can include retrieving metadata associated with the at least one node and at least one data type of the identified metadata and loading, using the generated access path, the identified metadata and retrieved associated metadata during runtime of the application. The loading can also include determining whether a runtime-loading structure for loading the metadata during runtime of the application has been previously generated and loading, using the previously generated runtime loading structure, the identified metadata during runtime of the application. If the runtime-loading structure has not been previously generated, a new runtime-loading structure for loading the identified metadata can be generated and the identified metadata can be loaded during runtime of the application using the new structure.

In some implementations, the generation of the runtime-loading structure can include generating the runtime-loading structure on a meta-metadata level (i.e., level M2) of the metadata repository based on the at least one metadata model. The generation of the structure can also include preparation of the identified metadata stored on a metadata level (i.e., level M1) of the metadata repository for loading during runtime of the application based on the runtime-loading structure. For example, a runtime-load that can be a business object metadata object model can be defined and generated on the M2 level of the metadata repository. This can enable automatic provisioning of runtime-load for at least one and/or all M1 level objects, which can include business object models, such as, sales orders, products information, customer information, etc.

In some implementations, the metadata can be loaded both at runtime and at design time of the application. This can enable various lifecycle management functionalities. For example, when a business object metadata model is changed/extended, the corresponding runtime-load catalogs and/or runtime-loading structures can be automatically updated.

In some implementations, the loading of the identified metadata can be optimized for performance during the runtime of the application.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
identifying a metadata associated with an application, wherein the metadata is configured to enable loading during a runtime of the application and is stored on at least one node in a metadata repository;
generating, based on the identified metadata, a runtime-loading structure for loading the metadata during the runtime of the application, the runtime-loading structure containing an identification of the at least one node storing the identified metadata in the metadata repository; and,
loading, based on the generated runtime-loading structure, the identified metadata during the runtime of the application;
wherein at least one of the identifying, the generating, and the loading is performed on at least one processor.

2. The method according to claim 1, wherein the generating further comprises
determining at least one attribute of the identified metadata; and
generating, using the determined attribute, an access path for accessing the identified metadata during runtime of the application.

3. The method according to claim 2, wherein the generation of the access path is performed on a metadata level of the metadata repository.

4. The method according to claim 3, wherein the loading further comprises
retrieving the identified metadata associated with the at least one node and at least one data type of the identified metadata; and
loading, using the generated access path, the identified metadata and retrieved associated metadata during runtime of the application.

5. The method according to claim 1, wherein the loading further comprises
determining whether a runtime-loading structure for loading the metadata during runtime of the application has been previously generated;
loading, using the previously generated runtime loading structure, the identified metadata during runtime of the application;
generating another runtime-loading structure for loading the identified metadata and loading the identified metadata during runtime of the application when the runtime-loading structure has not been previously generated.

6. The method according to claim 1, wherein the metadata is loaded based on at least one metadata model stored in the metadata repository.

7. The method according to claim 6, wherein the generating further comprises
generating, based on the at least one metadata model, the runtime-loading structure on a meta-metadata level of the metadata repository; and
preparing, based on the runtime-loading structure, the identified metadata stored on a metadata level of the metadata repository for loading during runtime of the application.

8. The method according to claim 1, wherein the loading further comprises loading the identified metadata during a design-time of the application.

9. The method according to claim 1, wherein the loading of the identified metadata is optimized for performance during the runtime of the application.

10. A computer-program product comprising a machine-readable medium storing instructions that, when executed by at least one programmable processor, cause the at least one programmable processor to perform operations comprising:
identifying a metadata associated with an application, wherein the metadata is configured to enable loading during a runtime of the application and is stored on at least one node in a metadata repository;
generating, based on the identified metadata, a runtime-loading structure for loading the metadata during the runtime of the application, the runtime-loading structure containing an identification of the at least one node storing the identified metadata in the metadata repository; and,
loading, based on the generated runtime-loading structure, the identified metadata during the runtime of the application.

11. The computer-program product according to claim 10, wherein the generating further comprises
determining at least one attribute of the identified metadata; and
generating, using the determined attribute, an access path for accessing the identified metadata during runtime of the application.

12. The computer-program product according to claim 11, wherein the generation of the access path is performed on a metadata level of the metadata repository.

13. The computer-program product according to claim 12, wherein the loading further comprises
retrieving the identified metadata associated with the at least one node and at least one data type of the identified metadata; and
loading, using the generated access path, the identified metadata and retrieved associated metadata during runtime of the application.

14. The computer-program product according to claim 10, wherein the loading further comprises
determining whether a runtime-loading structure for loading the metadata during runtime of the application has been previously generated;
loading, using the previously generated runtime loading structure, the identified metadata during runtime of the application;
generating another runtime-loading structure for loading the identified metadata and loading the identified metadata during runtime of the application when the runtime-loading structure has not been previously generated.

15. The computer-program product according to claim 10, wherein the metadata is loaded based on at least one metadata model stored in the metadata repository.

16. The computer-program product according to claim 15, wherein the generating further comprises
generating, based on the at least one metadata model, the runtime-loading structure on a meta-metadata level of the metadata repository; and
preparing, based on the runtime-loading structure, the identified metadata stored on a metadata level of the metadata repository for loading during runtime of the application.

17. The computer-program product according to claim 10, wherein the loading further comprises loading the identified metadata during a design-time of the application.

18. The computer-program product according to claim 10, wherein the loading of the identified metadata is optimized for performance during the runtime of the application.

19. A system comprising:
at least one programmable processor; and
a machine-readable medium storing instructions that, when executed by the at least one programmable processor, cause the at least one programmable processor to perform operations comprising:
identifying a metadata associated with an application, wherein the metadata is configured to enable loading during a runtime of the application and is stored on at least one node in a metadata repository;
generating, based on the identified metadata, a runtime-loading structure for loading the metadata during the runtime of the application, the runtime-loading structure containing an identification of the at least one node storing the identified metadata in the metadata repository; and,
loading, based on the generated runtime-loading structure, the identified metadata during the runtime of the application.

20. The system according to claim 19, wherein the generating further comprises
determining at least one attribute of the identified metadata; and
generating, using the determined attribute, an access path for accessing the identified metadata during runtime of the application.
